(19) United States
(12) Patent Application Publication
(10) Pub. No.: US 2007/0104641 A1
(43) Pub. Date: May 10, 2007

(54) Method of controlling oxygen addition to a steam methane reformer

(76) Inventors: M. Mushtaq Ahmed, Pittsford, NY (US); James Patrick Meagher, Buffalo, NY (US); Edward Scott Jurasevich, Crown Point, IN (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/268,531

(22) Filed: Nov. 8, 2005

(51) Int. Cl. C01B 3/26

(52) U.S. Cl. 423/652

(57) ABSTRACT

A method is disclosed for controlling addition of a supplementary oxygen stream into a steam methane reformer utilizing both the supplementary oxygen stream and a primary oxidant stream to support combustion of a fuel stream by burners firing into a radiant section of the reformer. The combustion generates heat to support endothermic heat requirements of the reforming reaction conducted in reformer tubes to obtain an enhanced rate of production of a product gas stream produced by the endothermic reaction. In the method, a temperature is obtained that is at least referable to a reformer tube wall temperature measured at a location of inlet regions of the reformer tubes at which a maximum temperature is produced at the enhanced rate of production. This temperature is controlled by regulating the flow rate of the supplementary oxygen stream to either prevent damage to the reformer tubes at such location at which the maximum temperature is produced or to maintain the maximum temperature if the same is less than a temperature that will damage the tubes.

### FIELD OF THE INVENTION

The present invention relates to a method of controlling oxygen addition of a supplementary oxygen stream to a steam methane reformer to obtain an enhanced production rate of a product. More particularly, the present invention relates to such a method in which the addition of the supplementary oxygen stream is controlled to obtain a temperature at inlet regions of reformer tubes of the steam methane reformer that does not exceed an allowable temperature of such tubes that is selected to prevent damage to the tubes or to obtain the maximum temperature at the enhanced production rate if the maximum temperature is below the allowable temperature.

### BACKGROUND OF THE INVENTION

There exist a variety of steam methane reformers that utilize reformer tubes containing a catalyst to conduct endothermic steam methane reforming reactions in which radiant heat is supplied to support the endothermic reactions. In a steam methane reformer, hydrocarbons contained in a feed are reacted with steam within the reformer tubes to produce a synthesis gas product that contains hydrogen and carbon monoxide. The synthesis gas can be further processed to produce such products such as methanol, hydrogen and carbon monoxide.

In a conventional steam methane reformer, the reformer tubes are housed within a radiant heat exchange region of the steam methane reformer. The heat necessary to support the endothermic steam methane reforming reaction is provided by burners firing into the radiant heat exchange section. The burners are designed to burn a fuel in which combustion is supported by an oxygen containing gas, typically air.

The heated flue gases produced by such combustion are discharged into a convective section that is connected to the radiant heat exchange section. Heat exchangers are housed within the convective section to recover heat from the heated flue gases for purposes of producing the steam and to preheat the hydrocarbon containing feed and optionally to preheat the combustion air. The flue gases are discharged from the convective section as stack gases. The convective heat transfer taking place within the convective section is forced convection produced by a draft fan connected to the end of the convective heat exchange section. It is to be noted that there may also be radiant heat transfer in initial portions of the convective section due to the high temperature of the combustion products leaving the radiant heat exchange section.

The steam methane reformer operates under specific design conditions to enable a synthesis gas to be produced that has a requisite hydrogen and carbon monoxide content and flow rate for the eventual use or further processing of the synthesis gas. In order to approach and then maintain operational design conditions, various operational parameters are controlled. Such parameters typically include flue gas temperature, outlet tube wall temperature of the reformer tubes, the temperature of the synthesis gas product and the oxygen content within the stack gases. Typically, the firing rate of the burners can be controlled by adjustment of the fuel flow rate to the burners. This will in turn control the amount of heat being supplied to the reforming reaction and therefore, the flue gas temperature, the outlet tube wall temperature and the product stream temperature. Another point of control is the rate at which reactants are fed to the reformer tubes. As this rate increases, the product stream temperature will fall and vice-versa under constant firing conditions. The stoichiometry of the combustion is controlled by sensing the oxygen concentration of the flue gases produced by the combustion and adjusting the amount of air or other oxidant fed to the burners. Typically, the combustion is conducted under slightly fuel lean conditions to insure that all of the fuel is consumed in the radiant heat exchange section.

As can be appreciated, these parameters are interrelated so that movement of one parameter will affect other parameters. For instance, if reactant flow rates are increased and nothing else is done, tube wall temperatures of the reformer tubes will tend to decrease as well as synthesis gas stream temperature. Thus, the flow rate of fuel and air to the burners has to be increased to account for the increased heating requirements. The flow of product, fuel and air is typically controlled in the manner outlined above.

U.S. Patent Application Serial No. 2003/0110693, discloses a method of increasing the production of a steam methane reformer by adding supplemental oxygen to the air or other oxygen containing gas used to support the combustion to generate more heat to support increased heating requirements. The supplemental oxygen can either be lanced into the radiant section or can be injected into the air or other primary oxidant being fed to the burners. The replacement of air with oxygen increases the useful amount of heat generated by the burners by decreasing the amount of nitrogen present. The level of control in this patent is to constrain maximum temperature rises, anywhere in the reformer, to be less than 200° C. over that which would have been observed with the use of air or other primary oxidant alone.

As will be discussed, the degree to which production can be enhanced within a steam methane reformer can be further refined to allow the amount of oxygen addition to be more precisely controlled.

### SUMMARY OF THE INVENTION

The present invention provides a method for controlling addition of a supplementary oxygen stream into a steam methane reformer utilizing both the supplementary oxygen stream and a primary oxidant stream. The supplementary oxygen stream and the primary oxidant stream support combustion of a fuel stream by burners firing into a radiant section of the steam methane reformer to support endothermic heating requirements of an endothermic reaction conducted in reformer tubes. An enhanced rate of production of a product gas stream produced by the endothermic reaction can be obtained from such supplementary oxygen addition.

In accordance with the present invention, a first temperature is obtained that is at least referable to a reformer tube wall temperature measured at a location of the inlet regions of the reformer tubes at which a maximum temperature is produced at the enhanced rate of production. The first temperature is controlled by increasing a first flow rate of the supplementary oxygen stream when the first temperature is below an inlet wall temperature target and vice-versa. The inlet wall temperature target is selected to either prevent damage to the reformer tubes at said location of the inlet regions of the reformer tubes at which said maximum temperature is produced or to maintain the maximum temperature at the location, whichever is less. The combustion of the fuel stream is maintained under a substantially constant stoichiometry by adjusting a second flow rate of the primary oxidant.

In reformer tubes in which the endothermic reaction is to be conducted, most of the reaction takes place at the inlet regions of the tubes due to the reactant concentration within such regions. As the reactant proceeds in the tubes, the reactant is consumed and the amount of reactant available for conversion decreases. As a consequence, more heat will be consumed at the inlet regions of the tube where most of the reaction takes place. Where supplementary oxygen is introduced to allow for enhanced production of the product, in a conventional steam methane reformer, the burner flames will tend to be more compact to supply more heat to such inlet regions of the reformer tubes.

The inventors have found that as the amount of oxygen is increased, the temperature of such inlet regions will increase at a given flow rate of the reactants. Most unexpectedly, the temperature of the reformer tubes at outlet regions from which product is being discharged will not increase at the same rate of increase as the inlet regions during enhanced rates of production. While not wishing to be held to any specific theory of operation, it is believed that under conditions of enhanced production, some of the heat is being carried away with the product stream.

The practical limitation on the enhancement is that the reformer tubes and/or the catalyst contained inside the reformer tubes will be damaged as a limiting temperature is approached at a maximum rate of production. At a rate of production that is less than the maximum rate, since the reformer tubes will not be damaged at the requisite temperature distribution of the reformer tubes because the maximum temperature will be less than the thermal limiting temperature, the point of control can be taken at the maximum temperature. In either case, the amount of oxygen that will be added to the combustion will be able to be accurately controlled and thus, conserve oxygen usage.

It is to be noted, that as used herein and in the claims, a first temperature is “at least referable” to the maximum temperature attained at a specific length of the reformer tubes when the same is an actual temperature measurement of the reformer tube or a measurement of flue gas temperature of flue gas produced by the combustion, either at or directly opposite the location of the maximum temperature rise or another location from which the temperature at the location can be derived through simulation or experimental data. The term “target” as used herein and in the claims, when used in connection with temperature or flow rate, means a specific temperature or flow rate plus or minus a tolerance. It is in a sense a narrow range with a sharp drop-off. The tolerance is set by the tolerance or the ability of the control system to control an applicable parameter such as temperature or the range that is acceptable for a parameter if less than the tolerance of the control system. For example, in case of temperature, the tolerance is typically plus or minus 5° C. The term “inlet regions” as used herein and in the claims and when used in connection with the reformer tubes means a location anywhere along the first half of the reformer tubes as measured from inlets thereof at which reactants enter such tubes. Further, the term “outlet regions” as used herein and in the claims, when used in connection with the reformer tubes, means a location within the second half length of the reformer tubes as measured from the inlet regions and from which the product is discharged.

As will be discussed in further detail below and as indicated above, the first temperature does not have to be the actual temperature measured at the location of the reformer tubes at which the maximum temperature is obtained under a given enhanced production rate. Rather, a radiant section temperature of flue gases produced by the combustion can be measured within the radiant section. The first temperature in such case can be equal to the reformer tube wall temperature measured at the location of inlet regions of the reformer tubes at which a maximum temperature is produced at the enhanced rate of production and the first temperature can be derived from the radiant section temperature of the flue gases by known techniques that will be discussed below. The radiant section temperature can be controlled to an inlet radiant section target temperature by increasing the first flow rate of the supplementary oxygen stream when the radiant section temperature is below the radiant section temperature target and vice-versa. The first temperature can then be controlled by increasing the inlet radiant section target temperature when the first temperature is below the inlet wall temperature target and vice-versa.

The radiant section temperature can be measured within the radiant section opposite to the location of inlet regions of the reformer tubes at which a maximum temperature is produced at a maximum enhanced rate of production.

When the reformer tubes are fabricated from the same material at both the inlet regions and outlet regions of the reformer tubes from which the product stream is discharged, the inlet wall temperature target selected to prevent damage to the reformer tubes can be equal to an outlet wall temperature target selected to prevent damage to outlet regions of the reformer tubes. The reformer tubes can be fabricated from two different materials to utilize lower cost lower temperature materials and as such, one of the two different materials utilized in the inlet regions is a material susceptible to thermal damage at a lower temperature than the other of the two materials utilized in outlet regions from which the product stream is discharged. In such case, the inlet wall temperature target selected to prevent damage to the reformer tubes is selected to prevent damage to the inlet regions of the reformer tubes.

In any embodiment of the present invention, the supplementary oxygen stream and the primary oxygen stream can be mixed together. Oxygen lancing is of course also possible. The stoichiometry of the combustion can be controlled by measuring flue gas oxygen concentration within flue gases produced by the combustion. The flue gas oxygen concentration can be controlled to be within a flue gas oxygen concentration target by increasing a second flow rate of the primary oxidant stream when the flue gas oxygen concentration is below the flue gas oxygen concentration target and vice-versa.

### BRIEF DESCRIPTION OF THE DRAWINGS

While the specification concludes with claims distinctly pointing out the subject matter that applicants regard as their invention, it is believed that the invention will be better understood when taken in connection with the accompanying drawings in which:

FIG. 1 is a schematic, fragmentary view of a steam methane reformer located within a hydrogen plant;

FIG. 2 is a logic diagram of the control of a flow controller used in the control of the addition of supplementary oxygen;

FIG. 3 is a logic diagram of the control of a temperature controller that is used to set flow control target into the controller used in the logic diagram of FIG. 2;

FIG. 4 is a logic diagram of the control of a temperature controller that is used to set the temperature target within the temperature controller used within the logic diagram of FIG. 3;

FIG. 5 is a logic diagram of an optional point of control for the flow controller used in connection with FIG. 2 when the supplementary oxygen is injected into the primary oxidant flow;

FIG. 6 is a graphical representation of the wall temperature profile of a reformer tube along its length pairing air as the primary oxidant and the use of supplementary oxygen;

FIG. 7 is a graphical representation of the temperature of the synthesis gas stream as measured along the reformer tubes in a direction from the inlet to the outlet; and

FIG. 8 is a graphical representation of the flue gas temperature within the steam methane reformer comparing air as the primary oxidant alone and the use of supplementary oxygen.

### DETAILED DESCRIPTION

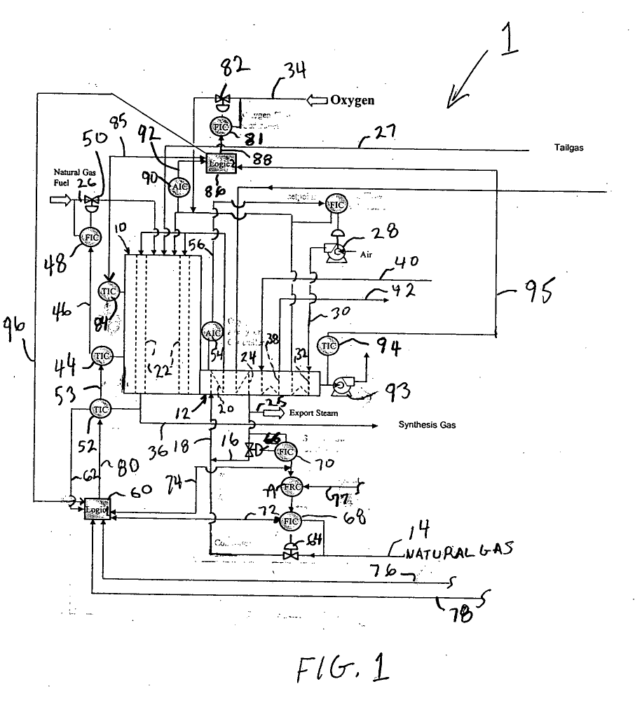

With reference to FIG. 1 a steam methane reformer 1 is illustrated. It is to be noted that although steam methane reformer 1 is designed to reform natural gas that has been pre-treated for the production of hydrogen, the present invention is not limited to such embodiment and has application to any steam methane reformer including reformers that are designed to process other feed stocks such as naphtha or refinery gases and to reformers that are used to produce synthesis gases for purposes other than the production of a hydrogen product.

As indicated above, steam methane reformer 1 is particularly designed to be used in a plant that produces hydrogen. For purposes of simplicity of explanation, various features, known in the art, that would be associated with such a plant, for instance, a shift converter, a hydrotreater and a pressure swing adsorption purification unit that would be used to purify the hydrogen and thereby to produce a tail gas stream are not shown. Also, other features of the installation that would be used in connection with steam methane reformer 1 such as those used for raising the steam required for the steam methane reforming reactions are also not shown. All of these features are well known and amply illustrated in the prior art.

Steam methane reformer 1 includes a radiant section 10 and a convective section 12. A natural gas stream 14 that has been hydrotreated and purified to remove sulfur species is combined with a steam stream 16 to form a combined stream 18. Combined stream 18 is preheated within a preheater 20 located within convective section 12 and introduced into reformer tubes 22 located within radiant section 10 of steam methane reformer 1. It is to be noted that steam stream 16 is superheated within a superheater 24 also located within convective section 12 and that an export steam stream 25 can be produced.

A fuel stream 26 is introduced into burners (not specifically illustrated) firing into radiant section 10 of steam methane reformer 1. Additionally, a tail gas stream 27 can also be introduced to provide part of the fuel to be injected by the burners. The fuel stream is typically natural gas. As well known in the art, such a tail gas stream 27 is derived from the separation of hydrogen to produce a hydrogen product by pressure swing adsorption. Conventionally, the combustion of fuel stream 26 is supported by air, although other oxygen containing gases can be used such as heated exhaust gases from a gas turbine. The air is introduced by a blower 28, as an air stream 30, into air preheater 32 located within convective section 12. Air stream 30 after having been preheated is introduced along with fuel stream 26 into the burners to support combustion within radiant section 10. The air contained within air stream 30 serves as a primary oxidant.

Supplementary oxygen by way of an oxygen stream 34 is combined with air stream 30 to support combustion of the burners located within radiant section 10 of steam methane reformer 1. Hence, air stream 30 is the primary oxidant and oxygen stream 34 constitutes a supplementary oxygen stream. In this regard, oxygen stream 34 should have a purity of at least about 25 percent by volume oxygen and preferably more than 80 percent oxygen by volume. The mixing of the oxygen stream 34 and the air stream 30 is accomplished by injecting oxygen stream 34 into air stream 30 leaving convective section 12. As will be discussed, such injection imposes a limitation on the amount of oxygen that can be mixed with air due to pressure, temperature, gas velocity and material of construction considerations. For oxygen levels greater than 23.5 percent oxygen by volume, special precautions are taken for cleaning and material selection to avoid combustion in the piping with enriched oxygen streams. Above 400° F., additional precautions must be made for the materials of construction. This is described in industry standard document CGA G-4.4 “Oxygen Pipeline Systems,” 4^{th} Edition published by Compressed Gas Association, Inc., Chantilly, Va., United States of America. Another possible manner of introducing the supplementary oxygen is by way of oxygen lancing and the provision of one or more lances to separately introduce oxygen into the radiant section 10.

The burners propagate a flame that externally heats reformer tubes 22 primarily by the mechanism of radiant heat exchange. Reformer tubes 22 contain a known catalyst to promote a reaction between the steam and methane contributed from the natural gas in an endothermic reaction known as the steam methane reforming reaction. This reaction produces a synthesis gas stream 36 as the product of the reforming and such stream contains hydrogen and carbon monoxide. This reaction is typically set forth as follows:
CH₄+H₂O←→CO+3H₂

Although the schematic illustration of reformer 1 contemplates that all burners are located at one end of the reformer and fire in a direction parallel with the reformer tubes 22, there are reformers in which burners fire not only from one end, but also from the refractory lined sides of the steam methane reformer 1. In such case, supplementary oxygen would be injected into the primary oxidant stream being fed to burners located near inlet regions of reformer tubes 22 or be lanced at locations near the inlet regions of the reformer tubes 22.

The flue gases or combustion gases produced by the burners are introduced into convective section 12 where convective heat exchange occurs between the various heat exchangers mentioned above. It is to be noted that in the illustration, a water evaporator 38 is provided to boil a water stream 40 and produce a steam stream 42 that, as would be known to those skilled in the art, is introduced into a steam header to help meet the steam requirements of the plant.

As indicated above, conventionally, steam methane reformer 1 is controlled to prevent failure of the reformer tubes 22 and to control the temperature of the synthesis gas stream 36 so that its composition is maintained within design limits. This is done directly or indirectly by controlling the firing rate of the burners. The firing rate of the burners is controlled by the amount of fuel introduced into the burners and therefore the amount of heat generated by the burners.

A flue gas temperature is obtained at the outlet of the steam methane reformer by a temperature sensor connected to a temperature controller 44. It is to be noted that the term “controller” as used herein means a program residing on a digital device such as a personal computer that generates a control signal in response to an input. There are many suppliers of such software and sensors and no particular vendor is preferred. Although the invention is not limited to any particular type of controller, the illustrated controllers are proportional, integral, differential controllers. Other devices such as pneumatic controller could also be used. In any event, the temperature sensor associated with temperature controller 44 is situated in the furnace at a location near the outlet ends of reformer tubes 22 from which the synthesis gas is discharged.

Set within temperature controller 44 is a target temperature. When the temperature sensed by the associated temperature sensor is above the target temperature, a control signal is generated that, as an input indicated by reference numeral 46, resets a target flow rate within a flow controller 48 that is below the previous target flow rate. Flow controller 48 then resets the valve position of a flow control valve 50 to decrease the flow of fuel stream 26. The reverse operation would occur when the temperature falls below its target temperature.

The temperature of synthesis gas stream 36 is sensed by a sensor connected to a temperature controller 52. At a specific pressure and steam to hydrocarbon feed ratio, the temperature of the synthesis gas stream is indicative of the degree of methane conversion and therefore, its composition. Temperature controller 52 is set with a target temperature for the synthesis gas stream 36. If the sensed temperature is greater than the target temperature of the synthesis gas stream 36, a control signal generated by temperature controller 52, transmitted by an input 53 to temperature controller 44, resets the target temperature set in temperature controller 44 to a lower value. This resetting will in turn have the effect of decreasing the fuel flow of fuel stream 26 or the firing rate of the burners. When the temperature of synthesis gas stream 36 is too low, the reverse operation occurs.

As can be appreciated, the adjustment of the rate of fuel stream 26 while potentially increasing or decreasing the amount of heat generated by the burners cannot alone accomplish adjustment of the firing rate. The primary oxidant flow, air stream 30 in the illustration, also has to be adjusted. This is done by sensing the oxygen concentration in the flue gas by way of an oxygen sensor 54 which by electrical connection 56 activates flow controller 58 to adjust the speed of blower 28 or flow control dampers depending on the method of control. This in turn adjusts the flow rate of air stream 30. If the current value of the oxygen concentration is outside of the oxygen concentration target, the target flow rate of the primary oxidant flow or the speed of blower 28 or inlet damper setting is changed to decrease or increase the target flow rate of air stream 30 so that combustion is near stoichiometric. In practice the combustion of the burner is conducted under slightly fuel-lean conditions to ensure that all of the fuel is burned within radiant section 10 and typically the target oxygen concentration is about 1.5 percent by volume. In this manner under impetus of varying flow rates for fuel stream 26 and air stream 30, the combustion occurring within radiant section 10 is maintained under a substantially constant stoichiometry.

The temperature of an outlet region of reformer tubes 22 is obtained by inferring an outlet temperature of the reformer tubes 22 through reactant flow rates of the natural gas stream 14, the steam stream 16 and the temperature of the flue gases at the outlet region as sensed by the temperature sensor associated with temperature controller 44. All of these parameters are set as an input to a calculation block of computer code programmed into a computer on which the controllers reside and designated by logic block 60 (“LOGIC 1” in the illustration). Logic block 60 computations could also be occurring in a more sophisticated model predictive controller. At logic block 60, a heat transfer coefficient is calculated for reformer tubes 22 and from this a tube wall temperature is calculated. As is well know in the art, the temperature of synthesis gas stream 36 could be used for such purposes as well as more direct measurements from optical pyrometers.

In order to effectuate such control, temperature controller 44 is coupled to logic block 60 by an input 62 to transmit the temperature of the flue gases at the outlet region of the radiant section as sensed by the temperature sensor associated with temperature controller 44. The flow of natural gas stream 14 and steam stream 16 is controlled by valves 64 and 66 that are in turn controlled by flow controllers 68 and 70, respectively, coupled to logic block 60 by inputs 72 and 74. Logic block 60 generates set points for flow controllers 68 and 70 to decrease or increase the flow rates of natural gas stream 14 and steam stream 16.

Additional inputs to logic block 60 are inputs 76 and 78 which are signals referable to the amount of methane in the product and the product pressure. Additionally, an input 77 to a flow ratio controller 79 is used to generate a flow target for flow controller 64. Input 77 is a signal referable to the methane concentration in the synthesis gas being fed to the pressure swing adsorption unit being used to purify the hydrogen product. If there is too much methane, for a given rate of flow for steam stream 16, also fed as an input to flow ratio controller 79 from flow controller 70, flow ratio controller generates a new target flow rate for flow controller 68 to reduce the flow rate of natural gas stream 14. In a hydrogen plant, the methane analyzer and pressure sensor would be at a cooler region of the plant, after the shift reactors and heat exchangers. As would be known in the art, there would be other controls placed upon steam methane reformer 1.

If the calculated tube wall temperature of the reformer tubes 22 at outlet regions thereof is above a target temperature, then the target temperature of the synthesis gas stream 36 might be slightly reduced and such target temperature would be fed as an input 80 into temperature controller 52. This would have the effect of eventually decreasing the firing rate. However, there are limits as to the amount that synthesis gas temperature should be allowed to decrease to avoid an upset due to product purity. Hence, past a preset temperature for the target temperature of synthesis gas product stream, the logic block 60 will generate new set points for flow controllers 68 and 70 as inputs along lines 72 and 74 to decrease the flow rates of the natural gas stream 14 and the steam stream 16. This will have the effect of momentarily increasing the temperature of the flue gases as sensed by the temperature sensor associated with temperature controller 44 to in turn decrease the firing rate of the burners.

The foregoing represents an explanation of conventional controls and control logic that are utilized for the control of a steam methane reformer. In fact, the control might very well be manually executed by an operator simply noting the temperatures of the flue gases, the oxygen content of the combustion gases, the temperature of the product stream and the tube wall temperature and making appropriate adjustments to valves to maintain such process parameters at acceptable target values. On the other hand, control can be more sophisticated with a model predictive controller providing the target settings for the controllers mentioned above.

In order to control the amount of supplemental oxygen addition, namely supplementary oxygen stream 34, a flow controller 81 is utilized to control a valve 82. Controller 81 upwardly increases the flow rate of supplementary oxygen stream 34 in response to a temperature sensed that is at least referable to a reformer tube wall temperature measured at a location of inlet regions of the reformer tubes 22 at which a maximum temperature is produced at the enhanced rate of production. As will be discussed below, this temperature can be an exact temperature measurement with the use of thermocouple or optical pyrometer or other known means used for such purposes. However, an exact temperature measurement does not have to be utilized and preferably, the temperature to be measured can be sensed by a temperature sensor coupled to a temperature controller 84. In such case, this temperature could be used alone or it could be used to derive the temperature at the location at which maximum tube wall temperature will occur at the inlet regions of reformer tubes 22 due to enhanced production and oxygen addition. It is preferred that such temperature be measured in the control of valve 82 in that the temperature of flue gases produced by combustion occurring within the radiant section 10 will change more rapidly than the actual temperature of the tube walls of inlet regions of the reformer tubes 22.

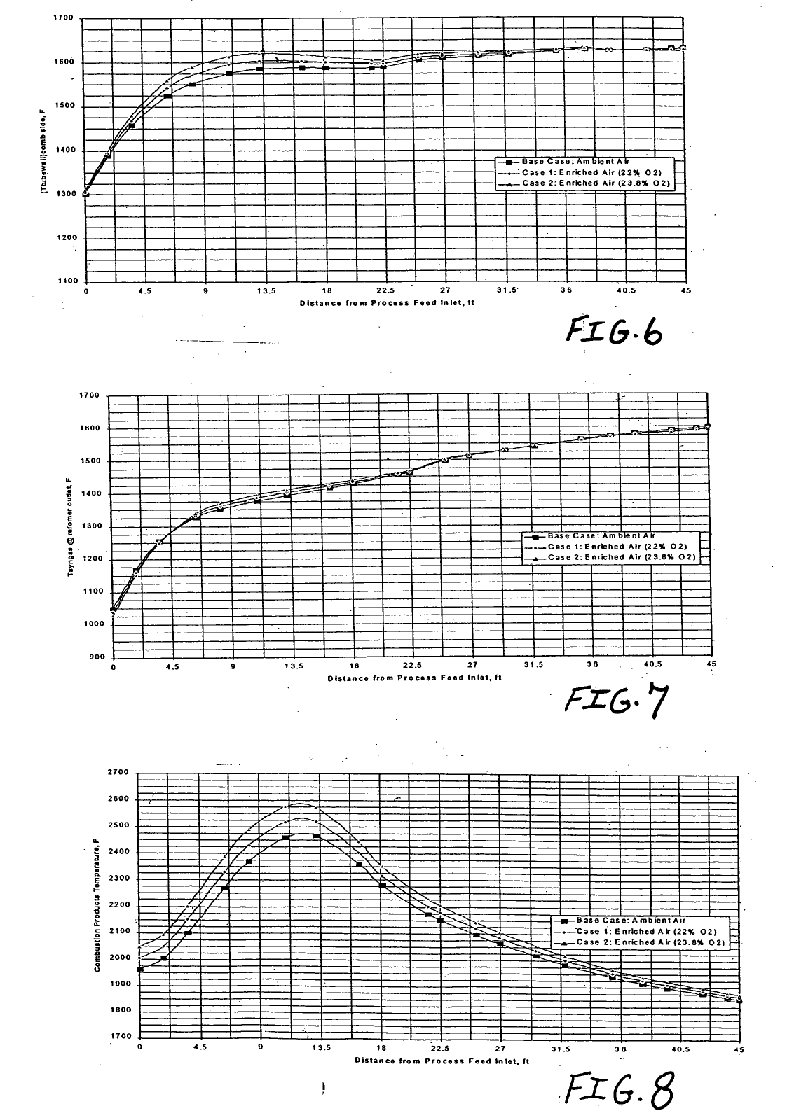

Preferably the temperature sensor coupled to temperature controller 84 is positioned opposite to the location of maximum tube wall temperature but it need not be so positioned in that combustion temperatures sensed at other locations within the inlet region of the radiant section 10 could also be used as a control point. The maximum tube wall temperature and its location are determined through simulation utilizing such techniques as are applicable to FIGS. 6, 7 and 8 discussed below and the same are preferably confirmed with simple experimental measurements at and near the point of maximum tube wall temperature that has been simulated. This confirmation will allow less of a factor of safety to be built into any temperature target. Typically, such maximum temperature will occur in the inlet region of radiant section 10 or the first half of such furnace and more particularly, within the first third distance of the length of the radiant section 10 which would be near the first third length of the reformer tubes 22.

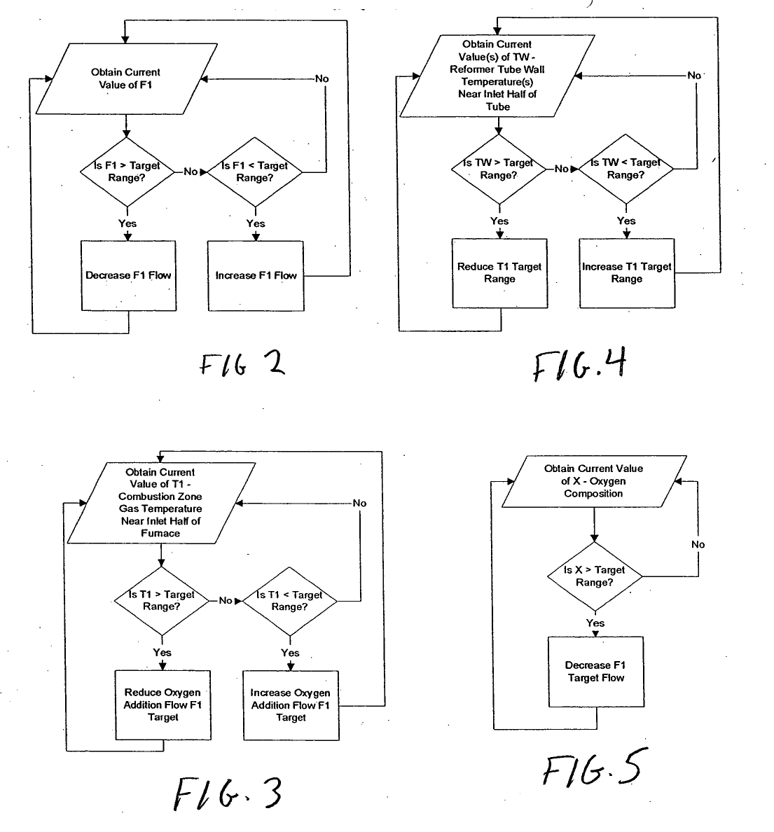

With reference to FIG. 2 and as indicated above, the flow rate of supplementary oxygen stream 34 (“Fl”) is controlled by flow controller 81. If the flow rate is greater than the target flow rate, flow controller 81 acts to decrease the flow rate of supplementary oxygen stream 34 through closing valve 82. Conversely, if the flow rate of supplementary oxygen stream 34 is less than the target flow rate, flow controller 81 increases the flow rate by opening valves 82. The target flow rate is set by another logic block 86 (“LOGIC 2”) connected to flow controller 81 by an input 88 to reset the flow rate target set within flow controller 81.

With reference to FIG. 3, a target temperature is set within temperature controller 84. The temperature sensed by the temperature sensor associated with temperature controller (“T1”) is transmitted to logic block 86 by way of input 85. When temperature “T1” is greater than the target temperature, then the flow rate target set within flow controller 81 is reduced to decrease the flow rate of supplementary oxygen stream 34 (“F1”). This reduction in target is computed within logic block 86 and the computation in a basic form is simply a ratio applied to the target temperature set within temperature controller 84 to determine the requisite flow to be set by flow controller 81. This ratio is determined by testing over a range of capacities or with a simulation calculation of the firebox if the flame characteristics with oxygen injection have been determined for the style of burner in use. Alternatively, the logic block 86 could have more sophisticated algorithms and it could be part of a model predictive control system.

Additionally, from the temperature T1 transmitted to logic block 86, a tube wall temperature is inferred by either a lookup table generated from temperature data gathered during operational testing at various conditions or a calculation based upon the method described in a Standard Number 530, Calculation of Heater Tube Thickness in Petroleum Refineries, Fifth Ed. January 2003 of the American Petroleum Institute published by API Publishing Services of Washington, D.C., United States of America. From the inferred tube wall temperature, a new target temperature is computed for temperature controller 84. The new target temperature is computed by a simple multiple of the difference between the target tube wall temperature minus the inferred tube wall temperature plus the old target temperature for T1. These computations occur within logic block 86. The overall logic is set forth in FIG. 4. Thus, as indicated, if the inferred tube wall temperature (“TW”) of an inlet region of the reformer tubes 22 is greater than a target temperature for the tube wall, then the logic block 86 computes a decrease in the target temperature for temperature controller 84 and transmits the same along line 85 to temperature controller 84 to decrease the flow of supplementary oxygen stream 34. The reverse operation occurs upon a tube wall temperature TW that is less than the target temperature of the inlet region of the reformer tubes 22.

Preferably, another input to logic block 86 is oxygen concentration sensed by oxygen sensor 90 and transmitted as an input 92. Here the limitation is that in injecting oxygen into the air, there exist velocity and material limitations related to combustion in the piping. Hence, when a specific oxygen concentration is reached, regardless of the state of temperature in the inlet region to the steam methane reformer 1 or an inferred or actual inlet tube wall temperature, any command to further open valve 82 will be overridden to prevent the mixture of oxygen and air from exceeding the material flammability limit. FIG. 5 represents the logic used. As illustrated, a target oxygen concentration is sensed and if the oxygen concentration (“X”) as sensed by oxygen sensor 90 is greater than the target oxygen concentration, a new target oxygen flow rate that is less than the previous flow rate is transmitted to flow controller 81 to close valve 82. If the oxygen concentration is less than the target, no control action is taken.

Preferably, temperature is sensed by a sensor between the convective section 12 and the draft fan 93. When such temperature exceeds a target temperature that is set to prevent damage to the draft fan 93, typically 500° F. or less, there is too much mass flow of the flue gases. In such case, a temperature controller 94 associated with the sensor provides an input 95 and logic block 86 computes an increase in F1 sent to flow controller 81 to increase the opening of valve 82 and the flow rate of supplementary oxygen stream 34 as long as the previously mentioned limits would not be exceeded. If the increase in F1 requested by controller 94 through logic block 86 is not allowed, for example, oxygen compatibility limits have been exceeded, then logic block 86 will send a signal to logic block 60 requesting a decrease in plant rate or the flow rates of natural gas stream 14 and steam stream 16 as input 96. This decrease will have an effect of momentarily increasing the flue gas temperature and the reformer tube outlet temperature which will in turn cause a decrease in the firing rate and that reduced mass flow will result in a reduced temperature at the draft fan. A possible control here would be a set percentage decrease in plant rate, for example 1 percent. A simulation using known techniques could also be used and programmed within logic block. Any increase in oxygen flow will also increase the oxygen concentration “X” to result in an eventual decrease in the flow rate of the air stream 30 caused by excessive oxygen sensed by oxygen sensor 54.

Assuming that steam methane reformer 1 is operating at an enhanced rate of production, the control action that either directly or indirectly depends on a temperature referable to that measured at a location of the inlet regions of the reformer tubes 22 at which a maximum temperature for a given enhanced production rate occurs will tend to make the temperature more uniform throughout the reformer tubes 22 to enable more product as synthesis gas stream 36 to be produced. However, since it is at the inlet region where the heat requirement exists, the adjustment of supplementary oxygen addition on such basis makes the control more direct and hence, the proper amount of oxygen will be utilized for the enhancement in production rate. The remainder of steam methane reformer is controlled as indicated above and either by manual means or by sophisticated automated control, as outlined above. However, for a given enhanced rate of production, the control of the temperature of the inlet regions of the reformer tubes 22 and that of the remainder of the plant are very compatible because increasing the temperature of such inlet regions as outlined above will not have the effect of a consummate temperature rise in the outlet regions of such tubes. Any such temperature increase can therefore be adjusted by the normal control of the steam methane reformer 1.

With reference to FIGS. 6, 7 and 8, simulations of oxygen addition were conducted. Three cases were simulated. The “BASE CASE” simulates a steam methane reformer operating at its design hydrogen production capacity of 70 MMSCFD (base operating point, 100 percent capacity). Cases 1 and 2 simulate increased production scenarios (109 percent and 118 percent, respectively). The simulation was obtained in a manner well known in the art utilizing simulations of heat release patterns by the burners and reactions with reformer tubes 22. Such simulation and modeling, albeit without supplementary oxygen addition, are routinely conducted for purposes of design and operation of steam methane reformers and their components. In case of the aforesaid figures, the simulations were conducted with the use of computer programs HYSYS® computer program sold by AspenTech of Cambridge, Massachusetts, United States of America and REFORM-3PC computer program sold by PFR Engineering Systems of Los Angeles, Calif., United States of America.

FIG. 6 shows tube metal temperature plotted as a function of the catalyst tube length, starting from the inlet end. The results of such simulation can be used to determine the maximum temperature that is achieved at a particular enhanced production rate and the location along the tube length of reformer tubes 22 at which such maximum temperature occurs. As is evident from this Figure, as the production rate is increased, more feed is processed through the catalyst tubes as well as more fuel is fired to supply the necessary heat for raising process feed temperature and for hydrogen producing endothermic reforming reactions. In each of Cases 1 and 2, the flow rates of natural gas stream 14 and steam stream 16, fuel stream 26, tail gas stream 27, air stream 30 and supplementary oxygen stream 34 were adjusted to obtain the maximum temperature of the reformer tubes 22 that would not exceed a thermal failure temperature of such tubes, combustion product flow, and excess oxygen in the flue gases at the same level. The following Table sets forth the flow rates of various numbered streams discussed above with respect to steam methane reformer 1.

| | TABLE | | | | | | | |
|---|---|---|---|---|---|---|---|---|
| | Refer. No. | | | | | | | |
| | 14 | 16 | 36 | 26 | 27 | 30 | 34 | Stack gas |
| Base Case, lb/h | 45923 | 151739 | 197663 | 15221 | 105662 | 557446 | 0 | 678324 |
| Case 1, lb/h | 50961 | 168430 | 219393 | 14544 | 116352 | 539409 | 10417 | 680596 |
| Case 2, lb/h | 56000 | 185121 | 241124 | 13863 | 127006 | 521745 | 20833 | 683186 |

The temperature of the reformer tubes 22 is lowest at the feed or inlet point and highest at the discharge or outlet point. An inspection of the Figure also discloses that at the production enhancement of Case 2, the maximum temperature occurred at about 14.75 feet and was equal to about 1605° F. This would be less than the thermal failure limit of the material used in forming reformer tubes 22 and hence, could be the tube wall temperature target to be utilized in logic block 86. Preferably, a test run could be used to confirm the location of the temperature sensor to be utilized in connection with temperature controller 84 and to confirm the maximum temperature attained. If such temperature sensor is placed opposite to the location of maximum temperature, then in practice logic block 86 will determine the approximate tube wall temperature from Standard Number 530 of the American Petroleum Institute discussed above. Although less preferable, the temperature could be sensed at another location, for example, at 9 feet and from such temperature, the tube wall temperature at the 9 feet location could be determined from Standard Number 530 and then, the tube wall temperature at 14.75 feet could be derived from the simulation.

Case 2 shows a maximum temperature of 1625° F. is attained at about 13.5 feet of tube length. Such information would be used in a similar manner to that of Case 1 discussed above. However, in Case 2 the maximum temperature is about equal to the outlet temperature of the reformer tubes 22 and hence, the target temperature would be the same target temperature used in the outlet section of reformer tubes 22, namely, a temperature selected to prevent thermal failure of the reformer tubes. As indicated above, reformer tubes 22 could be manufactured from two different materials and the less expensive and lower temperature material could be used for manufacturing the inlet regions of reformer tubes 22. In such case, the target temperature would be the lower temperature selected to prevent thermal failure of the reformer tubes 22. If steam methane reformer 1 is to be used at a variety of enhanced production rates then the temperature sensor associated with temperature controller 84 might be situated at the location of Case 2, about 13.5 feet and the temperature target for other enhanced production rates might be derived from other similar simulations.

As evidenced by FIG. 7 by the synthesis gas temperature or the reaction temperature computed inside the reformer tubes 22, the temperature inside the reformer tubes near the feed end is lower as more feed is processed. However, it is to be noted that the temperature in all three cases approaches nearly the same value at the discharge ends of catalyst filled tubes 22. Similarly, with reference to FIG. 8 and with respect to flue gas temperature, the gas temperature outside the reformer tubes 22 is lowest near the feed or inlet end, maximum some distance from the feed or inlet end (corresponding to the maximum heat release point) and then approaches nearly the same lower value at the discharge or outlet end of the reformer tubes 22. The surprising result however, is that these temperatures change much more in the first one-third to one-half of the catalyst tube length as oxygen flow is increased to increase hydrogen production while maintaining the set point for excess oxygen at same target value. Furthermore, unexpectedly, the temperature at the outlet ends of the reformer tubes 22, either with respect to inside the reformer tubes 22 or at the surface of the reformer tubes 22 or the temperature of flue gases at the outlet of the reformer tubes 22 remained essentially unchanged. As indicated above, the flue gas temperature could be used alone to act as a target temperature and as evident from FIGS. 6, 7 and 8, such temperature would also be referable to the maximum temperature attained in reformer tubes 22 at an enhanced rate of production at a specific length of reformer tubes 22.

Although the present invention has been described with referenced to preferred embodiments, as will occur to those skilled in the art, numerous, changes, additions and omissions can be made without departing from the spirit and scope of the present invention.

We claim:

1. A method for controlling addition of a supplementary oxygen stream into a steam methane reformer utilizing both the supplementary oxygen stream and a primary oxidant stream to support combustion of a fuel stream by burners firing into a radiant section of the steam methane reformer to support endothermic heat requirements of a steam methane reforming reaction conducted in reformer tubes to obtain an enhanced rate of production of a product gas stream produced by the steam methane reforming reaction, said method comprising:
obtaining a first temperature that is at least referable to a reformer tube wall temperature measured at a location of inlet regions of the reformer tubes at which a maximum temperature is produced at the enhanced rate of production; controlling the first temperature by increasing a first flow rate of the supplementary oxygen stream when the first temperature is below an inlet wall temperature target and vice-versa, the inlet wall temperature target being selected to either prevent damage to the reformer tubes at said location of the inlet regions of the reformer tubes at which said maximum temperature is produced or to maintain the maximum temperature at said location, whichever is less; and
maintaining the combustion of the fuel stream under a substantially constant stoichiometry by adjusting a second flow rate of the primary oxidant.

2. The method of claim 1, wherein a radiant section temperature of flue gases produced by the combustion is measured within the radiant section, the first temperature is equal to reformer tube wall temperature measured at a location of inlet regions of the reformer tubes at which a maximum temperature is produced at the enhanced rate of production and the first temperature is derived from the radiant section temperature of the flue gases.

3. The method of claim 2, wherein:
the radiant section temperature is controlled to be within a radiant section temperature target by increasing the first flow rate of the supplementary oxygen stream when the radiant section temperature is below the radiant section temperature target and vice-versa; and
the first temperature is controlled by increasing the radiant section temperature target when the first temperature is below the inlet wall temperature target and vice-versa.

4. The method of claim 3, wherein the radiant section temperature is measured within the radiant section opposite to said location of inlet regions of the reformer tubes at which a maximum temperature is produced at the enhanced rate of production.

5. The method of claim 1, wherein the reformer tubes are fabricated from the same material at both the inlet regions and outlet regions of the reformer tubes from which the product stream is discharged and the inlet wall temperature target selected to prevent damage to the reformer tubes is equal to an outlet wall temperature target selected to prevent damage to outlet regions of the reformer tubes.

6. The method of claim 1, wherein the reformer tubes are fabricated from two different materials, one of the two different materials being utilized in the inlet regions being a material susceptible to thermal damage at a lower temperature than the other of the two materials utilized in outlet regions from which the product stream is discharged and the inlet wall temperature target selected to prevent damage to the reformer tubes is selected to prevent damage to the inlet regions of the reformer tubes.

7. The method of claim 1, wherein the supplementary oxygen stream and the primary oxygen stream are mixed together.

8. The method of claim 1, wherein the stoichiometry of the combustion is controlled by measuring flue gas oxygen concentration within flue gases produced by the combustion and controlling the flue gas oxygen concentration to be within a flue gas oxygen concentration target by increasing the second flow rate of the primary oxidant stream when the flue gas oxygen concentration is below the flue gas oxygen concentration target and vice-versa.

9. The method of claim 3, wherein the radiant section temperature is measured within the radiant section opposite to said location of inlet regions of the reformer tubes at which a maximum temperature is produced at a maximum enhanced rate of production.

10. The method of claim 3, wherein the reformer tubes are fabricated from the same material at both the inlet regions and outlet regions of the reformer tubes from which the product stream is discharged and the inlet wall temperature target selected to prevent damage to the reformer tubes is equal to an outlet wall temperature target selected to prevent damage to outlet regions of the reformer tubes.

11. The method of claim 3, wherein the reformer tubes are fabricated from two different materials, one of the two different materials being utilized in the inlet regions being a material susceptible to thermal damage at a lower temperature than the other of the two materials utilized in outlet regions from which the product stream is discharged and the inlet wall temperature target selected to prevent damage to the reformer tubes is selected to prevent damage to the inlet regions of the reformer tubes.

12. The method of claim 3, wherein the stoichiometry of the combustion is controlled by measuring flue gas oxygen concentration within flue gases produced by the combustion and controlling the flue gas oxygen concentration to be within a flue gas oxygen concentration target by increasing the second flow rate of the primary oxidant stream when the flue gas oxygen concentration is below the flue gas oxygen concentration target and vice-versa.

13. The method of claim 12, wherein the supplementary oxygen stream and the primary oxygen stream are mixed together.
